(19) United States
(12) Patent Application Publication
(10) Pub. No.: US 2026/0238442 A1
(43) Pub. Date: Aug. 13, 2026

(54) METHODS FOR ENHANCEMENTS OF HARQ DOWNLINK FOR PROVISIONING SERVICES WITH DIFFERENT RELIABILITY AND LATENCY

(71) Applicant: InterDigital Patent Holdings, Inc., Wilmington, DE (US)

(72) Inventors: Ognen OGNENOSKI, London (GB); Filipe CONCEICAO, London (GB); Alain MOURAD, Ascot (GB); Yugeswar Deenoo NARAYANAN THANGARAJ, Chalfont, PA (US); Oumer TEYEB, Montreal (CA); Patrick TOOHER, Montreal (CA); Janet STERN-BERKOWITZ, Little Neck, NY (US); Benoit PELLETIER, Roxboro (CA); James MILLER, Northport, NY (US)

(73) Assignee: InterDigital Patent Holdings, Inc., Wilmington, DE (US)

(21) Appl. No.: 19/155,461

(22) PCT Filed: Feb. 12, 2024
(86) PCT No.: PCT/US2024/015350

§ 371 Date: Aug. 11, 2025

Related U.S. Application Data
(60) Provisional application No. 63/445,528, filed on Feb. 14, 2023.

(51) Int. Cl. H04L 5/00; H04L 1/00; H04L 41/16; H04W 72/232

(52) U.S. Cl. CPC H04L 5/0055; H04L 1/0058; H04L 41/16; H04W 72/232

(57) ABSTRACT

A WTRU may be configured to receive a first configuration information indicating a first number of code block groups (CBGs), receive a first DL scheduling information, and receive the first TB. The first TB may be comprised of the first number of CBGs. The WTRU may be configured to transmit a HARQ-ACK or a HARQ-NACK for each of the first number of CBGs, determine a second number of CBGs based on at least one of: a measurement, a current rate of ACK-to-NACK, or an estimation of packet delay or latency, determine a precision metric associated with the second number of CBGs, receive a second configuration information indicating a third number of CBGs, receive a second DL scheduling information that indicates a transmission of a second TB, receive the second TB, and transmit a HARQ-ACK or HARQ-NACK for each of the third number of CBGs.

### COSS-REFERENCE TO RELATED APPLICATIONS

This application claims the benefit of U.S. Provisional Application No. 63/445,528 filed Feb. 14, 2023, the contents of which are incorporated herein by reference

### BACKGROUND

For downlink, at a wireless transmit/receive unit (WTRU) side, for hybrid automatic repeat request (HARQ) functionality, the WTRU receives protocol data units (PDUs) and sends acknowledgement (ACKs)/negative acknowledgments (NACKs) using procedures from the Medium Access Control (MAC) layer and physical (PHY) layer. At a gNB side, there is a MAC scheduler (Sch) and a transmission buffer (Tx) responsible for sending PDUs and receiving ACKs/NACKs.

### SUMMARY

A wireless transmit/receive unit (WTRU) may be configured to receive a first configuration information indicating a first number of code block groups (CBGs). The WTRU may be configured to receive a first downlink (DL) scheduling information that indicates transmission of a first transport block (TB). The WTRU may be configured to receive the first TB. The first TB may be comprised of the first number of CBGs. The WTRU may be configured to transmit a hybrid automatic repeat request (HARQ)-acknowledgment (ACK) or a HARQ-negative acknowledgement (NACK) for each of the first number of CBGs. The WTRU may be configured to determine a second number of CBGs based on at least one of: a measurement, a current rate of ACK-to-NACK, or an estimation of packet delay or latency. The WTRU may be configured to determine a precision metric associated with the second number of CBGs. The precision metric may be at least one of: a confidence interval, an error margin, or an accuracy coefficient. The WTRU may be configured to transmit an indication of the determined second number of CBGs and the determined precision metric. The WTRU may be configured to receive a second configuration information indicating a third number of CBGs. The WTRU may be configured to receive a second DL scheduling information that indicates a transmission of a second TB. The WTRU may be configured to receive the second TB. The WTRU may be configured to transmit a HARQ-ACK or HARQ-NACK for each of the third number of CBGs. The WTRU may be configured to use an artificial intelligence (Al) model for determining the second number of CBGs. The AI model may be sent by a gNB. The WTRU may receive the AI model based on registration to a network. The WTRU may receive the AI model receives the AI model based on association to a network cell where a reconfiguration operation is supported. Inputs to the AI model may comprise: packet data units (PDUs) delay or latency; PDUs packet loss; PDUs ACKs/NACKs statistical information such as average number of ACKs/NACKs in predefined time interval, variations of the time instances when these ACKs/NACKs are sent; PDUs code block error distribution of code block errors; soft buffer status statistics; or receiver characteristics. The determined second number of CBGs may provide a highest possible probability of decoding the CBGs. The determined second number of CBGs may provide a probability of decoding the CBGs below a threshold value. The first DL scheduling information may be a downlink control information (DCI). The second TB may be comprised of the third number of CBGs.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example mapping of HARQ and ARQ on RLC and MAC layers of a WTRU and gNB for 5G NR;

FIG. 3 shows an example of 5G NR HARQ data units hierarchy;

FIG. 4 shows an example simplified view of the WTRU MAC layer architecture in 3GPP, focusing on HARQ;

FIG. 5 shows an example network to WTRU HARQ downlink communication;

FIG. 6 shows an example of common and newly introduced blocks to the WTRU MAC layer legacy architecture;

FIG. 7 shows an example logical flows between a WTRU and a network, where an algorithm is performed by the WTRU;

FIG. 8 shows an example of logical flows between a WTRU and a network, where an algorithm is performed by the network;

FIG. 9 shows an example method for reconfiguration of the number of CBGs; and

FIG. 10 shows an example flow diagram of a WTRU indication of the optimal number of CBGs for HARQ transmission.

### DETAILED DESCRIPTION

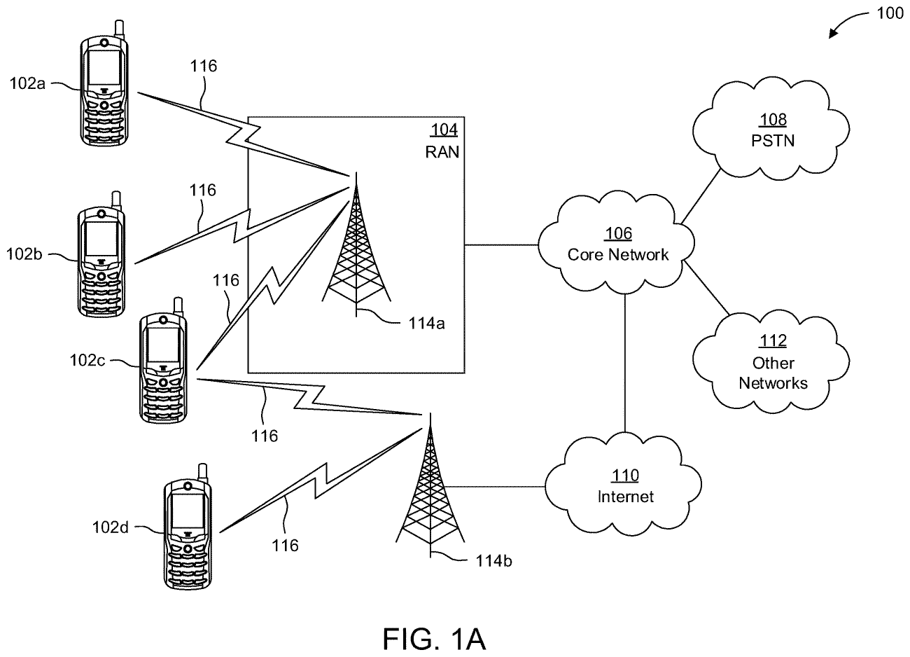

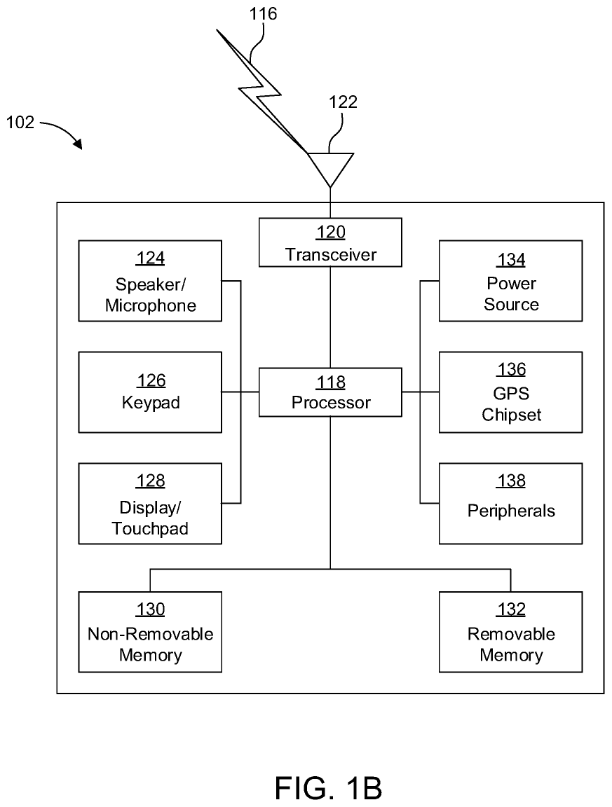

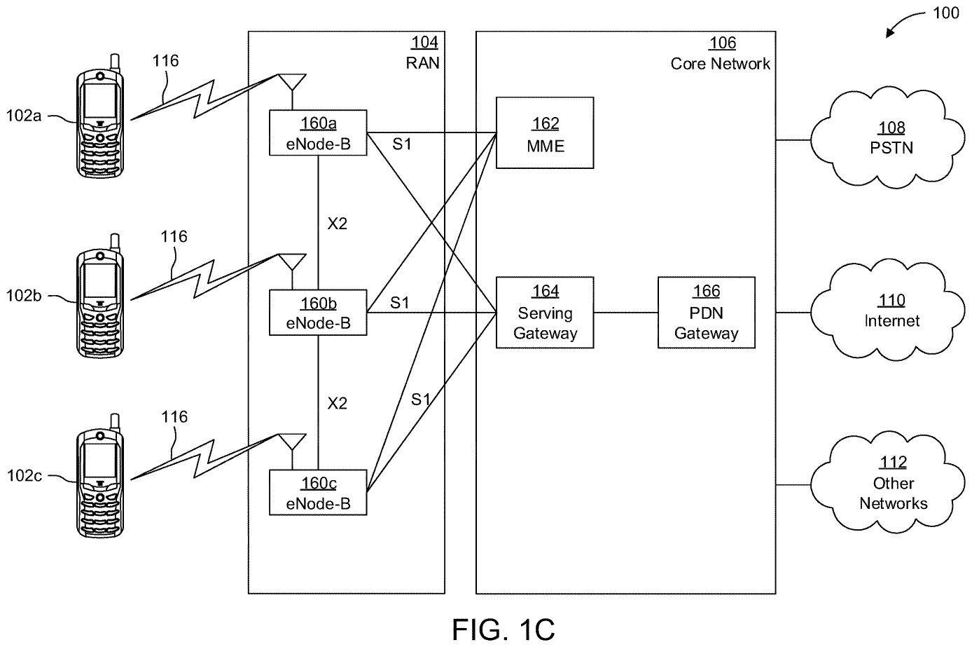

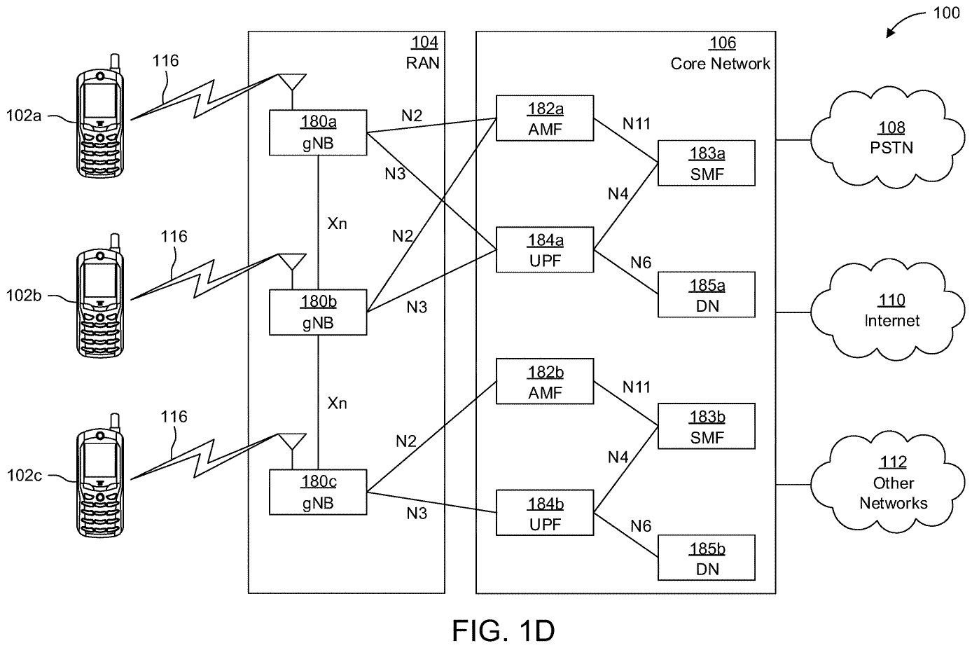

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

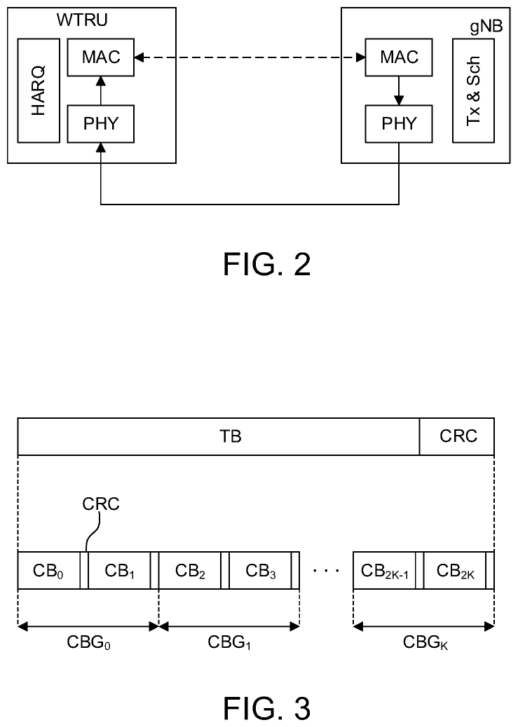

FIG. 2 shows a mapping of the HARQ at a WTRU and a gNB. The solid line between the PHY indicate the data flow in the downlink and the dashed line between the MAC indicate the logical link for the feedback and signaling.

A current HARQ implementation relies on a set of fixed or semi-static parameters that are configured in the WTRU via RRC configuration or are network-configured and specific for an entire cell. HARQ may be a stop-and-wait asynchronous and adaptive protocol. A WTRU associated to a service cell may have one MAC entity and one HARQ entity that manages a variable number of HARQ processes where the stop-and-wait procedure is enforced. Each HARQ process handles the delivery of one PDU for which the sender entity waits for an ACK from the receiver entity before transmitting the next PDU. Being asynchronous allows for flexible scheduling of HARQ transmissions. The adaptivity refers to the usage of an adaptive code rate that may be adjusted based on the channel quality. The main HARQ functionalities for successful delivery of a PDU may include forward error correction (FEC) via soft combing of PDUs and retransmissions of erroneous PDUs via sending acknowledgements and negative acknowledgments (ACKs/NACKs).

The FEC via soft combining is a PHY layer functionality based on buffering erroneous PDUs and using these with the retransmitted PDUs to perform decoding. Retransmission coordinated via ACKs and NACKs is a MAC layer functionality based on following preconfigured timing reports indicating if a PDU has been correctly received (ACK) or it has been received incorrectly or has not been received within the expected time window (NACK). The HARQ functionalities directly impact the communication latency and reliability. The operation on the PHY and MAC layer allows establishment of a HARQ transmission loop between the WTRU and the gNB that may result in a variable transmission latency and reliability performance. If this performance is not sufficient for a service, procedures from the upper layers (e.g. ARQ or TCP control mechanisms) must be invoked.

Two types of HARQ are Incremental Redundancy (IR-HARQ) and chase combining HARQ. For IR-HARQ, a different Redundancy Version (RV) is used for each of the retransmissions such that the number of coded bits increases with each retransmission and thus the probability of decoding is increased. Four different RVs may be used and the maximum number of retransmissions may be set to three. For chase combining HARQ, only one RV may be used and the same PDU is retransmitted and combined to increase the probability of successful decoding.

Regardless of the type of HARQ, the probability of successful decoding of the PDU is an important metric and if the PDU is not eventually decoded, it is discarded and left to the upper layers to work on successful delivery of the PDU.

The HARQ data may be structured such that the largest unit is called a Transport Block (TB) and it fits inside one MAC PDU. TBs may be transmitted by the MAC layer, however, these are large data units and if an error occurs and the data unit is not decodable, then network resources are under-utilized. Therefore, smaller units are introduced called Code Block Groups (CBGs) such that one TB may have one or multiple CBGs. The smallest unit is called a Code Block (CB) and the number of CB inside a CBG may be fixed and may be specified by a RRC message.

FIG. 3 shows a HARQ data structure hierarchy, starting from a TB to a CB, where k denotes the number of CBGs inside a TB, and each CBG has a fixed number of two CBs, hence 2k CB are used to represent the entire information from a TB. HARQ retransmissions may occur on a TB level or CBG level (i.e. CBs are not retransmitted). A rationale behind this is that retransmitting a CB may lead to extensive signaling, thus reducing performance. A WTRU may acknowledge multiple TB/CBGs in case of configured Carrier Aggregation (CA), and the RRC configured codebooks show how many ACK/NACK bits are sent and how these bits are packed.

In the downlink, the HARQ transmissions may occur on a physical downlink shared channel (PDSCH) channel, and feedback may be sent over a physical uplink control channel (PUCCH) or physical uplink shared channel (PUSCH). A gNB may send a Downlink Control Information (DCI) message indicating several control information such as a New Data Indicator (NDI) which the WTRU may use to determine if this is a new transmission (NDI is toggled) or a retransmission (NDI is not toggled). Two available DCI formats are format 1-0 and format 1-1. In the case of a new transmission, the WTRU may flush the soft buffer, whereas for retransmissions, the WTRU may use the buffer for soft combining and improving the decoding. The WTRU may follow a timing report and send an ACK or NACK back to the gNB. If the CBG retransmissions are configured, the WTRU may determine which CBGs are retransmitted using additional fields (e.g. two additional fields) in the DCI. A field may be a CBG Transmit Indicator (CBGTI) which may indicate whether a certain CBG is present in the downlink transmission. The CBGTI may be a bitmap. Another field may be a CBG Flush Indicator (CBGFI) which may indicate whether the CBG should be flushed or used in soft combining. The CBGFI may be one or more bits.

Different configurations of the HARQ downlink parameters provide different trade-offs between transmission reliability and latency when using a variable transmission link. The embodiments herein are tailored as an improvement to the existing HARQ downlink procedure by introducing adaptation of the HARQ relevant parameter over time. This is done using a new functionality based on a model or an algorithm that may run or be executed at or by the WTRU or at or by the network (e.g. gNB) The model or algorithm may be an empirical, a probabilistic estimation, or an AI inference that facilitates holistic adaptation of the HARQ parameters by providing predictions/estimations/inferences regarding the variability of the underlying link. These may be calculated or determined with an assigned precision metric (e.g. confidence interval, error margin, accuracy coefficient or combination of these). A goal is to use the output of such model or algorithm and to tune the HARQ procedure so that it enables MAC layer provisioning of services with different reliability and latency requirements without the need to invoke procedures from the higher layers (e.g. ARQ on RLC layer, or TCP on Transport Layer.).

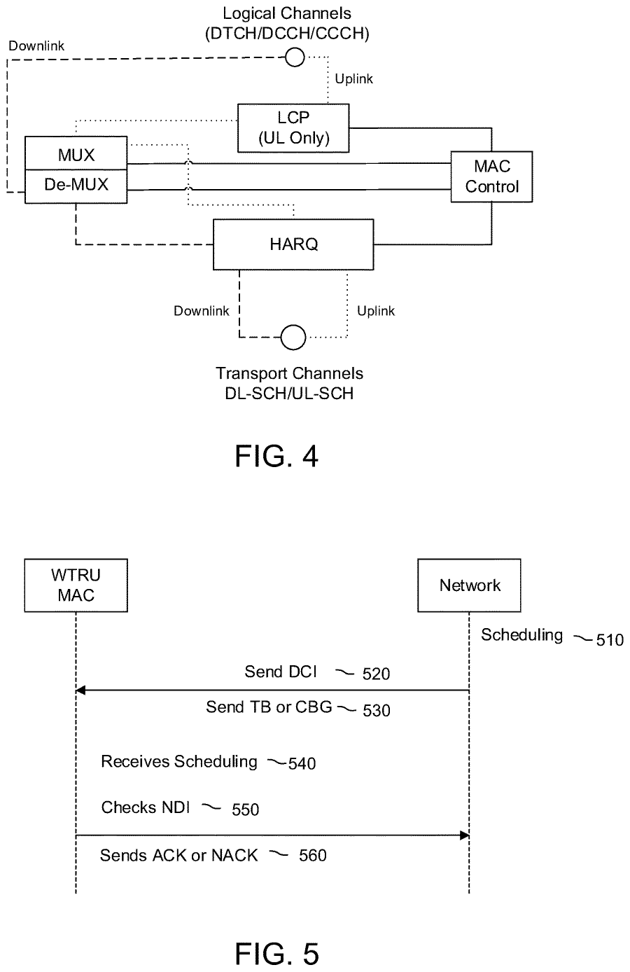

The current 3GPP releases for 5G NR support HARQ error correction and retransmission procedures for WTRU received (downlink) data in a static approach that relies on a set of fixed parameters, that are configured in the WTRU via RRC configuration or are network configured and specific to an entire cell. The HARQ procedure cannot adapt to the current radio link conditions and/or network DL scheduling for a specific user without reconfiguration of the WTRU and/or network planning changes. A simplified view of the current architecture, focusing on the HARQ, is shown in FIG. 4, where the entire MAC layer performs multiplexing and demultiplexing of PDUs between transport and logical channels coordinated by the MAC control block. The logical channel prioritization (LCP) is only valid for uplink.

A downlink HARQ PDU exchange between a WTRU and a gNB starts with the PDU arriving at the gNB that follows the slot alignment and introduces a scheduling delay upon which the PDU is transmitted to the WTRU, which introduces a processing delay. The WTRU replies with a ACK or NACK depending whether the PDU is correctly decoded. The ACK/NACK is processed at the gNB, and in case of a NACK, a retransmission is initiated after a scheduling delay, and in case of a ACK, a new transmission is initiated after a scheduling delay.

FIG. 5 shows an example of network (e.g. gNB) to WTRU downlink communication. Downlink scheduling at the network may be performed 510. A DCI may be sent from the network to the WTRU 520. The DCI may be sent with control information required to configure HARQ parameters. A TB or a CBG may be sent from the network to the WTRU 530. The WTRU may receive the DCI information 540. The WTRU may check the NDI in the DCI 550. The WTRU may send an ACK or NACK 560, based on a network configured timing report, to report on the successful or unsuccessful transmission of the TB or CBG. The network side controls the HARQ parameter configuration in a static or semi-static way, and once configured, the WTRU keeps executing the same network received configuration, despite any changes and variations in the underlying transmission link. There is no active participation of the WTRU side in the HARQ parameter configuration.

There is a problem of how to determine and include information from the WTRU side for adjusting the downlink HARQ parameters over future time transmission intervals with a goal of achieving better management of the latency-reliability transmission trade-off on the MAC layer.

The WTRU information relevant to tuning the HARQ parameters may in some cases not be timely available and/or kept by the network (e.g. statistics such as successful PDU delivery, statistics on using the soft buffer at the WTRU for decoding purposes), thus actively including the WTRU in the tuning of the HARQ parameters may enable a holistic approach for optimizing HARQ.

In an embodiment, a WTRU may send an indication to change the number of CBGs.

Based on measurements or using an algorithm (e.g. empirical, probabilistic, online/offline trained Al model, or combination of these), the WTRU may determine and indicate an optimal number of CBGs over a future time window (e.g. expressed as TTI) and a precision metric for this indication (e.g. confidence interval, error margin, accuracy coefficient or combination of these). This is what the WTRU sees as best fit for usage considering its own estimations based on variations of the underlying physical link.

In an embodiment, a WTRU may request a change to the number of CBGs. The WTRU may receive a first configuration information indicating a first number of CBGs. The WTRU may receive a first DL grant information that schedules transmission of a first TB. The WTRU may receive the first TB. The first TB may be comprised of the first number of CBGs. The WTRU may transmit a HARQ-ACK or a HARQ-NACK for each of the first number of CBGs. The WTRU may determine a second number of CBGs. The WTRU may determine the second number of CBGs based on one or more measurements. The WTRU may determine the second number of CBGs based on a current rate of ACK-to-NACK. The WTRU may determine the second number of CBGs based on predictions of packet delay or latency. The WTRU may determine the second number of CBGs based on a combination of any of the above elements or at least one of the above elements. The WTRU may use an AI model to determine the second number of CBGs. The determined second number of CGS may provide a highest possible probability of decoding the CBGs. The determined second number of CBGs may provide a probability of decoding the CBGs below a threshold value. The WTRU may determine a precision metric associated with the determined second number of CBGs. For example, the precision metric may be a confidence interval, error margin, or accuracy coefficient. The WTRU may transmit an indication of the determined second number of CBGs and associated precision metric. The WTRU may receive a second configuration information indicating a third number of CBGs. The WTRU may receive a second DL grant information that schedules transmission of a second TB. The WTRU may receive the second TB. The second TB may be comprised of the third number of CBGs. The WTRU may transmit a HARQ-ACK or a HARQ-NACK for each of the third number of CBGs. The first number of CBGs may be a first maximum number of CBGs and the second number of CBGs may be a second maximum number of CBGs. The second number of CBGs may be the same or different than the third number of CBGs.

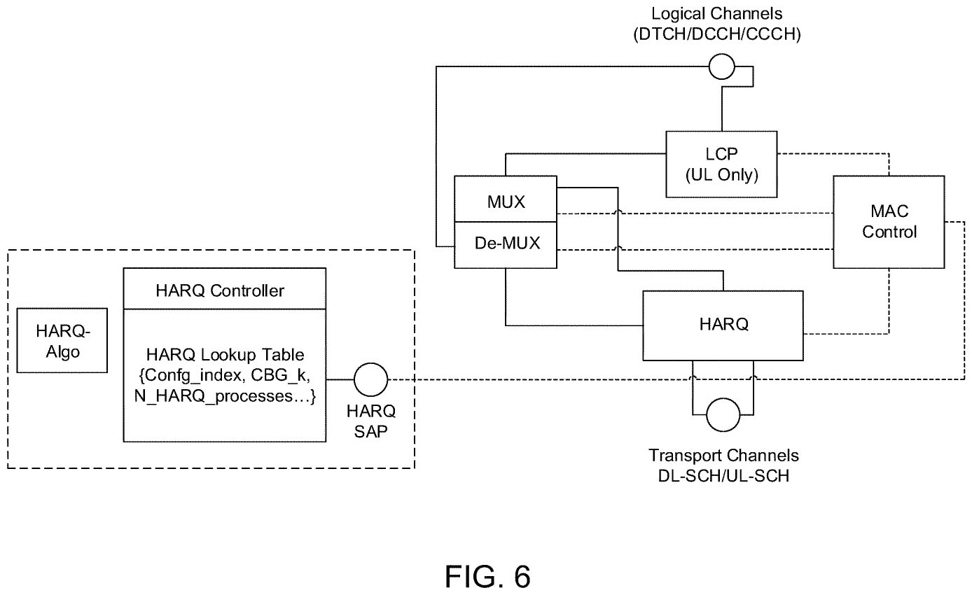

In an embodiment, WTRU-specific information may be included that may improve a decision taken by the network to adjust the HARQ parameters dynamically over time. FIG. 6 shows the common and newly introduced blocks to the WTRU MAC layer legacy architecture (as shown in FIG. 4) to facilitate the implementation of the proposed embodiment. The common and newly introduced blocks are highlighted with a dashed rectangle and the interaction with the current architecture is via the MAC control block. These entities include a HARQ Service Access Point (SAP), a HARQ Controller, and a HARQ algorithm (Algo).

A HARQ-SAP, is a Service Access Point (SAP), which is an interface used to communicate with the referent architecture bi-directionally. It is used to read the actual values for the HARQ parameters, but also to monitor MAC and PHY layer related parameters which may be relevant inputs in the common blocks.

A HARQ controller is an entity that controls the execution of the algorithm using the input parameters. It may create and populate entries, for example a HARQ lookup table, from which it may select the best value for a given HARQ parameter as seen from the WTRU side. Using the MAC control block this configuration may be signaled towards the network. The HARQ lookup table may comprise element such as a configuration index (Config_index), a CBG (CBG_k), and HARQ processes (N_HARQ_processes).

A HARQ-Algo (algorithm) is an entity or a block where an algorithm (e.g. empirical, probabilistic estimation or AI inference) may be executed to provide predictions/estimations/inferences regarding the optimal HARQ parameter values with a certain precision metric. This may be used to populate entries at the HARQ controller (e.g. in the HARQ lookup table).

The architecture enhancements shown in FIG. 6 compared to the current architecture, shown in FIG. 4, show a change of a current operation, shown in FIG. 5, as proposed in FIG. 6.

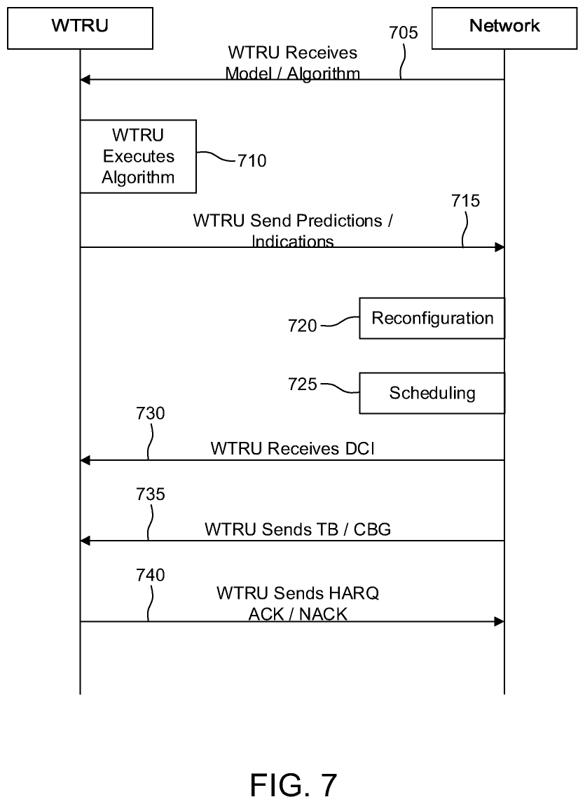

FIG. 7 shows an example logical flow procedure between a WTRU and a network (e.g. gNB) where a model or an algorithm is executed by the WTRU. The WTRU may receive a model or algorithm or be pre-configured with the model or algorithm 705. The pre-configuration may include: an agreement between the network and the WTRU (e.g. MAC) on where to execute an algorithm, determining the algorithm type, and exchanging additional information relevant to initial set up such as data format entries. The WTRU may receive the model through a pre-configuration procedure where the network transfers, sends, or indicates the model to the WTRU and is required to be used as part of the HARQ procedure. The WTRU may receive the model through registration to the network where the model is transferred, sent, or indicated as part of the registration. The WTRU may receive the model through an association to a particular network cell where this operation is supported (i.e. a model is transferred, sent, or indicated and available only in a predefined number of network cells).

The WTRU may execute the algorithm 710. The WTRU may send predictions/indications to the network 715. The predictions/indications may be via a lookup table or value for a particular parameter. The predictions/indications may refer to the number of CBGs. This number of CBGs may be what the WTRU predicts what the best number of CBGs would be, based on the measured transmission parameters or states. This best number of CBGs may means that when this “best” number of CBGs is used, the probability of successful decoding is a highest (e.g., above a threshold value).

The network may perform reconfiguration 720. The network may perform reconfiguration considering the WTRU predictions/indications. The network may perform scheduling 725. The network may send and the WTRU may receive downlink control information (DCI) 730. The DCI may indicate scheduling information. The DCI may include modified information based on the WTRU predictions/indications. The network may send and the WTRU may receive a TB/CBG 735. The TB/CBG that the network sends may be modified based on the WTRU predictions/indicators. Modifications as a result of the network reconfiguration may occur when no residual retransmissions are pending at the network since reconfiguring during retransmission may lead to misalignment such as when the WTRU expects one size of a TB/CBG but receives another, and the CBGFI bitmap would have an unexpected format and size, or indicators for non-active HARQ processes may be exchanged. The WTRU may send a HARQ ACK or NACK 740. The HARQ ACK/NACK may be sent based on or in response to the received TB/CBG. The HARQ ACK/NACK may be sent based on or in response to a timing report (e.g. network configured timing). The HARQ ACK/NACK may be sent based on or in response to a new data indicator (NDI) in the DCI. The WTRU may send a HARQ ACK if the TB/CBG was successfully decoded. The WTRU may send a HARQ NACK if the TB/CBG was not successfully decoded. The network may perform a fallback procedure and discard the WTRU predictions/indications or measurements and continue executing without reconfiguration. The fallback may be triggered when performance degradation is significant (e.g. large number of NACKs are received).

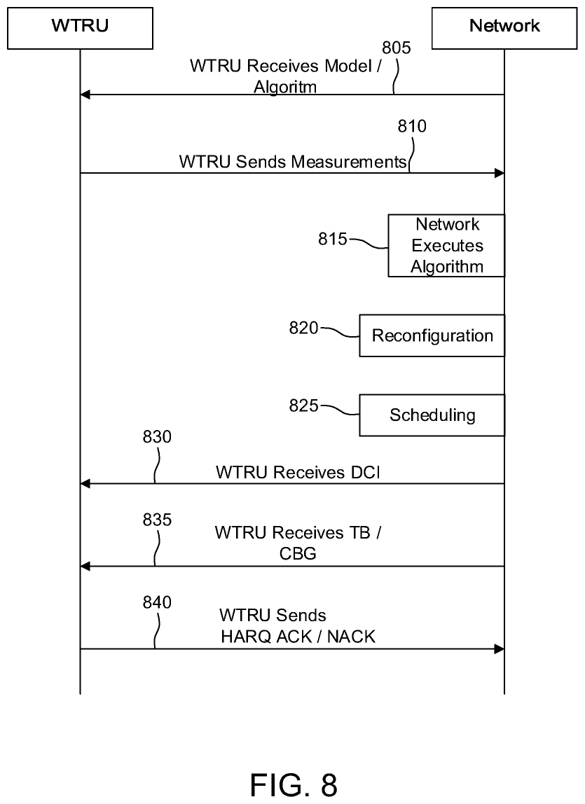

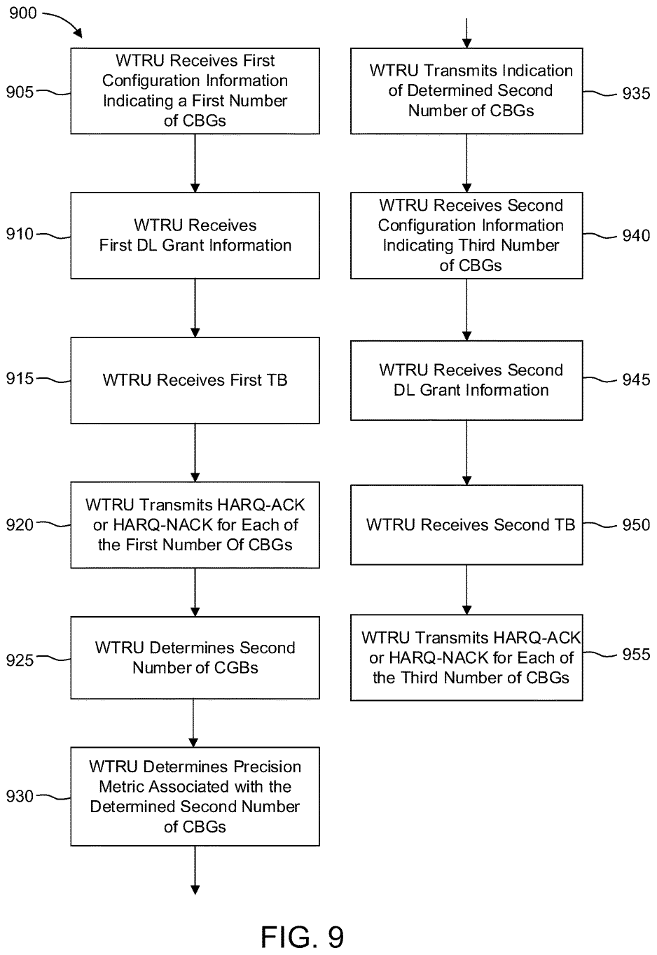

FIG. 8 shows an example logical flow procedure between a WTRU and a network (e.g. gNB) where a model or an algorithm is executed by the network. The WTRU may receive a model or algorithm or be pre-configured with the model or algorithm 805. The pre-configuration may include: an agreement between the network and the WTRU (e.g. MAC) on where to execute an algorithm, determining the algorithm type, and exchanging additional information relevant to initial set up such as data format entries. The WTRU may receive the model through a pre-configuration procedure where the network transfers, sends, or indicates the model to the WTRU and is required to be used as part of the HARQ procedure. The WTRU may receive the model through registration to the network where the model is transferred, sent, or indicated as part of the registration. The WTRU may receive the model through an association to a particular network cell where this operation is supported (i.e. a model is transferred, sent, or indicated and available only in a predefined number of network cells).

The WTRU may send measurements/inputs for the algorithm to the network 810. The measurements/inputs may be provided via a lookup table. The measurements/inputs may be sent as a data stream. The measurement/inputs may be for example: PDUs delay/latency; PDUs packet loss; PDUs ACKs/NACKs statistical information such as average number of ACKs/NACKs in predefined time interval, variations of the time instances when these ACKs/NACKs are sent; PDUs code block error distribution of Code Block Errors; soft buffer status statistics; or receiver characteristics (sensitivity thresholds). The network may execute the algorithm 815. The network may perform reconfiguration 820. The reconfiguration may be based on the algorithm execution. The network may perform scheduling 825. The network may send and the WTRU may receive a DCI 830. The DCI may indicate scheduling information. The DCI may include modified information based on the WTRU measurements/inputs and based on the algorithm execution. The network may send and the WTRU may receive a TB/CBG 835. The TB/CBG that the network sends may be based on the WTRU measurements/inputs. Modifications as a result of the network reconfiguration may occur when no residual retransmissions are pending at the network since reconfiguring during retransmission may lead to misalignment such as when the WTRU expects one size of TB/CBG but receives another, and the CBGFI bitmap would have unexpected format and size, or indicators for non-active HARQ processes can be exchanged. The WTRU may send a HARQ ACK or NACK 840. The HARQ ACK/NACK may be sent based on or in response to a timing report (e.g. network configured timing). The HARQ ACK/NACK may be sent based on or in response to a new data indicator (NDI) in the DCI. The WTRU may send a HARQ ACK if the TB/CBG was successfully decoded. The WTRU may send a HARQ NACK if the TB/CBG was not successfully decoded. The network may perform a fallback procedure and discard the WTRU measurements/inputs and continue executing without reconfiguration. The fallback may be triggered when performance degradation is significant (e.g. large number of NACKs are received).

Including WTRU-based information in a reconfiguration request/decision may be beneficial since the granularity of the information at the WTRU regarding statistics such as ACK/NACK and soft buffering decoding performance, such as how close was the WTRU when decoding a retransmission, is not scalable to be kept at the network especially for large number of users. Including WTRU-based information in a reconfiguration request/decision may be beneficial since receiver specific characteristics such a sensitivity/decoding performance are not available at the network side.

An underlying link refers to the physical over-the-air link between a WTRU and gNB, where variations of latency and reliability occur due to propagation, fading, and similar wireless phenomena.

The ability to perform MAC layer provisioning of services with different reliability and latency requirements without the need to invoke procedures from the higher layers such as RLC (e.g. operation of ARQ) and transport layer (TCP control mechanism) are beneficial.

In an embodiment, a WTRU may send an indication to change the number of CBGs.

Based on measurements or using an algorithm (e.g. empirical, probabilistic, online/offline trained Al model or combination of these), the WTRU may determine and indicate an optimal number of CBGs over a future time window (e.g. expressed as TTI) and a precision metric for this indication (e.g. confidence interval, error margin, accuracy coefficient or combination of these). This is what the WTRU sees as best fit for usage considering its own estimations based on variations of the underlying physical link.

FIG. 9 shows an example method of a WTRU requesting a change to the number of CBGs 900. The WTRU may receive a first configuration information indicating a first number of CBGs 905. The configuration information may be received, for example, from upper layers or received in a DCI. The WTRU may receive a first DL grant information that schedules transmission of a first TB 910. The DL grant information may be a DCI. The DCI may be received over a physical downlink control channel (PDCCH). The WTRU may receive the first TB 915. The first TB may be received, for example, over a PDSCH. The first TB may be comprised of the first number of CBGs. The WTRU may transmit a HARQ-ACK or a HARQ-NACK for each of the first number of CBGs 920. The WTRU may determine a second number of CBGs 925. The WTRU may determine the second number of CBGs based on one or more measurements. The measurement may be, for example, PDUs delay/latency, PDU packet loss, statistical information on ACKs and NACKs, PDUs code block error distribution, soft buffer status statistics, and/or receiver characteristics (e.g. sensitivity thresholds). The WTRU may determine the second number of CBGs based on a current rate of ACK-to-NACK. The WTRU may determine the second number of CBGs based on an estimation or prediction of packet delay or latency, for example, a delay of a TB or how long it took for the TB to be delivered from the network to the WTRU. The WTRU may determine the second number of CBGs based on a combination of any of the above elements or at least one of the above elements. The WTRU may use an AI model to determine the second number of CGBs. Inputs to the AI model may comprise PDUs delay/latency; PDUs packet loss; PDUs ACKs/NACKs statistical information such as average number of ACKs/NACKs in predefined time interval, variations of the time instances when these ACKs/NACKs are sent; PDUs code block error distribution of Code Block Errors; soft buffer status statistics; or receiver characteristics (e.g. sensitivity thresholds). The determined second number of CBGs may provide a highest possible probability of decoding the CBGs. The determined second number of CBGs may provide a probability of decoding the CBGs below a threshold value (e.g. network configured threshold). The WTRU may determine a precision metric associated with the determined second number of CBGs 930. For example, the precision metric may be a confidence interval, error margin, or accuracy coefficient. The precision metric may be statistical metrics. For example, the confidence interval may be an interval in which it is expected to contain the parameter being estimated, following the formula: CI=Xmean+z(S/sqrt(n)) where Xmean is the sample mean, z is confidence level value, s is standard deviation and n is sample size. The WTRU may transmit an indication of the determined second number of CBGs and associated precision metric 935. For example, the WTRU may transmit the indication over a control channel. The WTRU may receive a second configuration information indicating a third number of CBGs 940. The WTRU may receive a second DL grant information -20 (e.g. DCI) that schedules transmission of a second TB 945. The WTRU may receive the second TB 950. The second TB may be comprised of the third number of CBGs. The WTRU may transmit a HARQ-ACK or a HARQ-NACK for each of the third number of CBGs 955. The first number of CBGs may be a first maximum number of CBGs and the second number of CBGs may be a second maximum number of CBGs. The second number of CBGs may be the same or different than the third number of CBGs.

A WTRU may indicate the optimal number of CBGs and a precision metric for HARQ transmission. In an embodiment, the WTRU may use an algorithm or model (e.g. empirical, probabilistic estimation or AI inference) for providing predictions/estimations and determining the best or optimal number of CBGs. The WTRU may receive the model through a pre-configuration procedure where the network transfers, sends, or indicates the model to the WTRU and is required to be used as part of the HARQ procedure. The WTRU may receive the model through registration to the network where the model is transferred, sent, or indicated as part of the registration. The WTRU may receive the model through an association to a particular network cell where this operation is supported (i.e. a model is transferred, sent, or indicated and available only in a predefined number of network cells).

The WTRU may determine the best or optimal number of CBGs using the algorithm by using measured transmission-related parameters or states as relevant inputs. For example, the WTRU may use one or a combination of any of the following: PDUs delay/latency; PDUs packet loss; PDUs ACKs/NACKs statistical information such as average number of ACKs/NACKs in predefined time interval, variations of the time instances when these ACKs/NACKs are sent; PDUs code block error distribution of Code Block Errors; soft buffer status statistics; or receiver characteristics (sensitivity thresholds).

The WTRU may determine the best number of CBGs using the algorithm such that it provides a highest possible probability of decoding the PDUs and/or keeps the probability of decoding below a predefined threshold. This may be performed with a certain precision metric (e.g. confidence interval, error margin, accuracy coefficient or combination of these).

Upon determining the best or optimal number of CBGs and an associated precision metric, the WTRU may choose to keep executing with the same network-received CBG number, or it may indicate to the network a different or alternative number of CBGs, and the precision metric for this indication. The determination of the best or optimal number of CBGs may be performed using the WTRU's computational resources and using the above listed real-time measurements or states obtained from the underlying data transmission. The precision metric relevant for the determined best or optimal number of CBGs may be calculated or determined using the WTRU's computational resources by comparing the model output values with the real-time measurements/states values. A trigger to indicate to the network a change in the number of CBGs may not generated if the prediction values cannot be calculated or determined, if the precision metric cannot be calculated or determined, or if the precision metric is calculated but it is below a threshold value (e.g. predefined threshold value). A trigger to indicate to the network a change in a number of CBGs may be generated if the prediction values are calculated or determined, or if the precision metric is calculated or determined but it is above a threshold value (e.g. predefined threshold value).

If a change in the number of CBGs is not indicated, there may be no reconfiguration and no change in behavior. If the WTRU indicates a change in the number of CBGs and the associated precision metric for this change, the network may keep executing with the initial or current number of CGBs and discard or disregard the WTRU indication, or the network may reconfigure the number of CBGs. The network may keep executing with the initial or current number of CBGs and discard or disregard the WTRU indication, if the precision metric is not satisfactory for the network, or the network resources are constrained, and the MAC scheduler cannot support the suggested change. The network may reconfigure the number of CBGs by ensuring that there are no residual PDUs waiting for retransmission, or start using the new CBGs number, as indicated by the WTRU.

If the network reconfigures the number of CBGs, the WTRU should expect to receive a modified control information indicating that reconfiguration has occurred and the HARQ PDUs will be transmitted with the new or modified number of CBGs. Hence, the WTRU should anticipate receiving a DCI comprising modified information reflecting the change of the number of CBGs (e.g. CBGFI or CBGTI) and changing the values in an information element (e.g. IE-PDSCH-ServingCellConfig) that may be used to configure the maximum number of CBGs (e.g. via a variable maxCodeBlockGroupPerTransportBlock).

If the network estimates a performance drop after reconfiguration, the WTRU should participate in the execution of a fallback procedure driven by the network where the number of CBGs is reverted to the initial or previously used number of CBGs, and this may be signaled via a modified control information to the WTRU.

A WTRU may send relevant measurements to the network where the algorithm is executed.

In an embodiment, the WTRU may not run an algorithm or provide any indications, however, the WTRU may act as a collector of relevant measurements for the algorithm and the assessment may be done at the network side. The WTRU may format and store locally the relevant measurements and the WTRU may send the stored measurements periodically to the network, when, for example, the medium is free and there is no user data transmissions.

In an embodiment, the WTRU may keep executing with the network received parameters (X) as the number of CBGs. The downlink service may have variable reliability and latency, as estimated by the network from the received ACKs and NACKs. To mitigate this effect, if the latency and reliability targets are not met, the network may initiate a pre-configuration and send a model or an algorithm (e.g. offline trained AI model) that the WTRU may use to make an estimation regarding an optimal number of CBGs (X*) to be used to meet certain latency and reliability targets.

The WTRU may store the received model and start to collect model inputs. The WTRU may keep executing on the same configuration, but it may use the received measurement link information as inputs in the model and predict the optimal number of CBGs and with a certain level of precision. The WTRU may execute the model and estimate X* with a precision metric. Based on the precision metric (level), the WTRU may indicate to the network the value for X* and the precision level. The network may make a decision and reconfigure to X*, but only after the Tx buffer at the network has no pending retransmissions. The network may signal the WTRU to use X* via a DCI or IE (e.g. IE PDSCH-ServiceCellConfig), and all the remaining standard procedures may be followed, however the downlink service may now be delivered using X* as a HARQ parameter, thus the target latency and reliability are met.

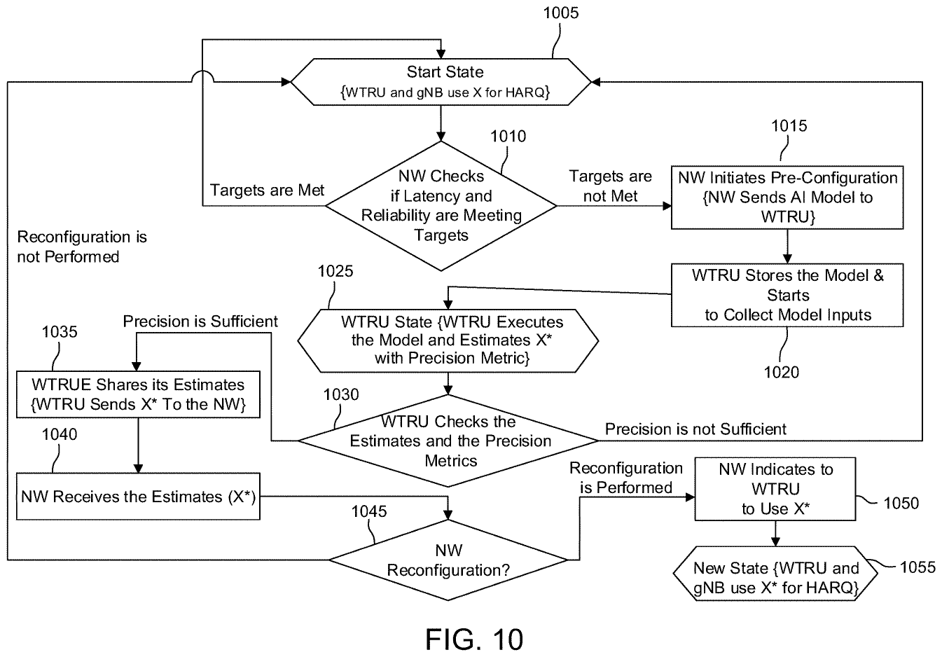

FIG. 10 shows an example flow diagram of reconfiguration of an optimal number of CBGs for HARQ transmission. The WTRU and the network (NW) (e.g. gNB) may use a first HARQ configuration (X) 1005. The first HARQ configuration may be a number of CBGs. The network may determine whether latency and reliability targets are met 1010. The network may determine whether latency and reliability targets are met by comparing latency parameters (e.g. delay of a TB, how long it takes for a TB to be delivered from the network to the WTRU) and/or reliability parameters (e.g. probability that a TB can be delivered, packet rate, error rate) against one or more threshold values. If the latency and reliability targets are met, the WTRU and gNB may keep using the current configuration. If the latency and reliability targets are not met, the gNB may initiate a pre-configuration 1015. The pre-configuration may comprise the gNB sending a model or algorithm (e.g. offline trained AI model) to the WTRU. The pre-configuration may include: an agreement between the network and the WTRU (e.g. MAC) on where to execute an algorithm, determining the algorithm type, and exchanging additional information relevant to initial set up such as data format entries. The WTRU may receive the model through a pre-configuration procedure where the network transfers, sends, or indicates the model to the WTRU and is required to be used as part of the HARQ procedure. The WTRU may receive the model through registration to the network where the model is transferred, sent, or indicated as part of the registration. The WTRU may receive the model through an association to a particular network cell where this operation is supported (i.e. a model is transferred, sent, or indicated and available only in a predefined number of network cells).

The WTRU may store the model and start collecting model inputs 1020. The model inputs may be measured transmission-related parameters or states. For example, the WTRU may use one or a combination of any of the following: PDUs delay/latency; PDUs packet loss; PDUs ACKs/NACKs statistical information such as average number of ACKs/NACKs in predefined time interval, variations of the time instances when these ACKs/NACKs are sent; PDUs code block error distribution of Code Block Errors; soft buffer status statistics; or receiver characteristics (sensitivity thresholds).

The WTRU may execute the model and estimate or determine an optimal number of CGBs (X*) and a precision metric 1025. For example, the precision metric may be a confidence interval, error margin, or accuracy coefficient The WTRU may determine whether the precision metric is sufficient 1030. The WTRU may determine whether the precision metric is sufficient by comparing the precision metric to a threshold value (e.g. network configured threshold value). If the precision metric is not sufficient, the WTRU and the gNB may keep using the current configuration. If the precision metric is sufficient, the WTRU may send an indication of the estimated or determined optimal number of CGBs (X*) to the gNB 1035. The gNB may receive the indication of the estimated or determined optimal number of CBG s (X*) from the WTRU 1040. The gNB may determine whether to reconfigure the number of CBGs 1045. The determination may be based on X and X *. If the gNB determines to not reconfigure the number of CBGs, the WTRU and gNB may continue using the current configuration. If the gNB determines to reconfigure the number of CBGs, the network may send information to the WTRU indicating a reconfiguration of the number of CBGs and to use X* 1050. The information may be sent via, for example, a DCI. The WTRU and gNB may use the reconfigured number of CGBs X* 1055.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
receiving first configuration information indicating a first number of code block groups (CBGs);
receiving first downlink (DL) scheduling information that indicates transmission of a first transport block (TB);
receiving the first TB, wherein the first TB is comprised of the first number of CBGs;
transmitting respective hybrid automatic repeat request (HARQ) feedback for each of the first number of CBGs;
determining a second number of CBGs based on at least one of: a measurement, a current rate of HARQ feedback, or an estimation of packet delay or latency;
determining a precision metric associated with the second number of CBGs, wherein the precision metric is at least one of: a confidence interval, an error margin, or an accuracy coefficient; and
transmitting an indication of the determined second number of CBGs and the determined precision metric.

2. The method of claim 1, further comprising:
using an artificial intelligence (AI) model for determining the second number of CBGs.

3. The method of claim 2, wherein the AI model is received from a base station.

4. The method of claim 2, wherein the WTRU receives the AI model based on registration to a network.

5. The method of claim 2, wherein the WTRU receives the AI model based on association to a network cell where a reconfiguration operation is supported.

6. The method of claim 2, wherein inputs to the AI model comprises at least one of: packet data units (PDUs) delay or latency; PDUs packet loss; average number of ACKs/NACKs in a predefined time interval; PDUs code block error distribution of code block errors; soft buffer status statistics; or receiver characteristics.

7. The method of claim 1, wherein the determined second number of CBGs provide a highest possible probability of decoding the CBGs.

8. The method of claim 1, wherein the determined second number of CBGs provide a probability of decoding the CBGs below a threshold value.

9. The method of claim 1, wherein the HARQ feedback comprises a HARQ acknowledgement (ACK) or a HARQ negative acknowledgement (NACK), and wherein a current rate of HARQ feedback comprises a rate of ACKs to NACKs over a predefined time interval.

10. The method of claim 1, further comprising:
receiving second configuration information indicating a third number of CBGs;
receiving second DL scheduling information that indicates transmission of a second TB;
receiving the second TB, wherein the second TB is comprised of the third number of CBGs; and
transmitting HARQ feedback for each of the third number of CBGs.

11. A wireless transmit/receive unit (WTRU) comprising:
a receiver;
a transmitter; and
a processor, wherein:
the receiver is configured to receive first configuration information indicating a first number of code block groups (CBGs);
the receiver is further configured receive first downlink (DL) scheduling information that indicates transmission of a first transport block (TB);
the receiver is further configured to receive the first TB, wherein the first TB is comprised of the first number of CBGs;
the transmitter is configured to transmit respective hybrid automatic repeat request (HARQ) feedback for each of the first number of CBGs;
the processor is configured to determine a second number of CBGs based on at least one of: a measurement, a current rate of HARQ feedback, or an estimation of packet delay or latency;
the processor is further configured to determine a precision metric associated with the second number of CBGs, wherein the precision metric is at least one of: a confidence interval, an error margin, or an accuracy coefficient; and
the transmitter is further configured to transmit an indication of the determined second number of CBGs and the determined precision metric.

12. The WTRU of claim 11, wherein the processor is further configured to use an artificial intelligence (AI) model to determine the second number of CBGs.

13. The WTRU of claim 12, wherein the receiver and the processor are further configured to receive the AI model from a base station.

14. The WTRU of claim 12, wherein the WTRU receives the AI model based on registration to a network.

15. The WTRU of claim 12, wherein the WTRU receives the AI model based on association to a network cell where a reconfiguration operation is supported.

16. The WTRU of claim 12, wherein inputs to the AI model comprises at least one of: packet data units (PDUs) delay or latency; PDUs packet loss; average number of ACKs/NACKs in a predefined time interval; PDUs code block error distribution of code block errors; soft buffer status statistics; or receiver characteristics.

17. The WTRU of claim 11, wherein the determined second number of CBGs provide a highest possible probability of decoding the CBGs.

18. The WTRU of claim 11, wherein the determined second number of CBGs provide a probability of decoding the CBGs below a threshold value.

19. The WTRU of claim 11, wherein the HARQ feedback comprises a HARQ acknowledgement (ACK) or a HARQ negative acknowledgement (NACK), and wherein a current rate of HARQ feedback comprises a rate of ACKs to NACKs over a predefined time interval.

20. The WTRU of claim 11, wherein:
the receiver is further configured to receive second configuration information indicating a third number of CBGs;
the receiver is further configured to receive second DL scheduling information that indicates a transmission of a second TB;
the receiver is further configured to receive the second TB, wherein the second TB is comprised of the third number of CBGs; and
the transmitter is further configured to transmit HARQ feedback for each of the third number of CBGs.
